(19) United States
(12) Patent Application Publication
(10) Pub. No.: US 2013/0010077 A1
(43) Pub. Date: Jan. 10, 2013

(54) THREE-DIMENSIONAL IMAGE CAPTURING APPARATUS AND THREE-DIMENSIONAL IMAGE CAPTURING METHOD

(76) Inventors: Khang Nguyen, Osaka (JP); Takashi Kawamura, Kyoto (JP); Shunsuke Yasugi, Osaka (JP)

(21) Appl. No.: 13/635,986

(22) PCT Filed: Dec. 15, 2011
(86) PCT No.: PCT/JP2011/007029

§ 371 Date: Sep. 19, 2012

(30) Foreign Application Priority Data
Jan. 27, 2011 (JP) 2011-015622

(51) Int. Cl. H04N 13/02; G06T 15/00

(52) U.S. Cl. 348/46; 345/419; 348/E13.074

(57) ABSTRACT

A three-dimensional image capturing apparatus generates depth information to be used for generating a three-dimensional image from an input image, and includes: a capturing unit obtaining the input image in capturing; an object designating unit designating an object in the input image; a resolution setting unit setting depth values, each representing a different depth position, so that in a direction parallel to a depth direction of the input image, depth resolution near the object is higher than depth resolution positioned apart from the object, the object being designated by the object designating unit; and a depth map generating unit generating two-dimensional depth information corresponding to the input image by determining, for each of regions in the input image, a depth value, from among the depth values set by the resolution setting unit, indicating a depth position corresponding to one of the regions.

### TECHNICAL FIELD

The present invention relates to three-dimensional image capturing apparatuses and three-dimensional image capturing methods and, in particular, to a three-dimensional image capturing apparatus and a three-dimensional image capturing method for generating depth information used for generating a three-dimensional image from an input image.

### BACKGROUND ART

There are conventional techniques to generate three-dimensional images from two-dimensional images based on depth information (depth map) indicating a depth value for each of regions in an image. The depth value indicates a direction of the depth of an image. For example, the depth value indicates a distance between a camera and an object. In order to obtain the depth information from an image captured with the camera, one depth value is to be determined out of predetermined depth values for each region of the image for the obtainment of the depth information.

For example, Patent Literature 1 discloses a technique to generate an all-focus image out of multiple images each having a different focal length. This technique makes it possible to generate a depth map indicating a depth value for each of pixels.

### CITATION LIST

### Patent Literature

### [PTL 1]

Japanese Unexamined Patent Application Publication No. 2001-333324

### SUMMARY OF INVENTION

### Technical Problem

Unfortunately, the above conventional technique cannot achieve compatibility between reduction of an increase in calculation cost and improvement in stereoscopic effect.

The conventional technique employs predetermined depth values. In other words, depth resolution is static. The depth resolution is a value to indicate how depth values vary with each other. The depth resolution is higher as a density of the values is higher. The depth resolution is lower as a density of the values is lower.

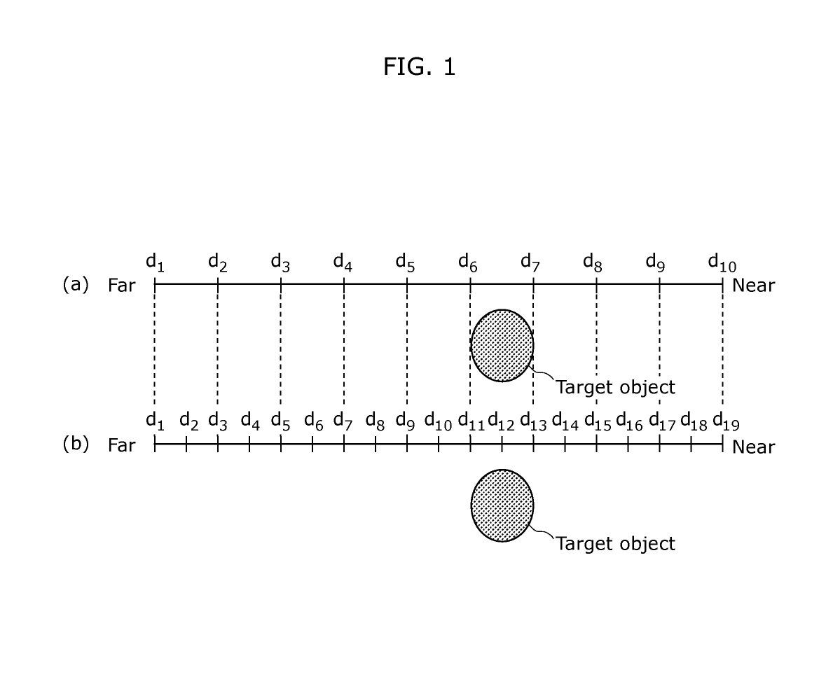

FIG. 1 shows a conventional depth resolution.

The illustration (a) in FIG. 1 shows that 10 depth values d₁ to d₁₀ are predetermined between the farthest end (longest focal length) and the nearest end (shortest focal length) of the camera. A depth value included in the depth information is selected from the predetermined 10 depth values d₁ to d₁₀. Here, the selected depth values for a target object are d₆ and d₇. In other words, only two values; namely, d₆ and d₇, represent the depth values for the target object. Thus, when an input image is converted into a three-dimensional image, the resulting image rarely expresses the three-dimensional appearance of the target object. Consequently, the generated three-dimensional image suffers from a cardboard effect.

In contrast, in the illustration (b) in FIG. 1, 19 depth values d₁ to d₁₉ are predetermined between the farthest end and the nearest end of the camera. Here, three values d₁₁, d₁₂, and d₁₃ represent the depth values of the target object. Thus, compared with the case (a) in FIG. 1, the case (b) in FIG. 1 makes it possible to obtain an improved three-dimensional appearance.

In order to determine the depth values of the target object, however, the case (b) requires calculation to each of the 19 depth values d₁ to d₁₉ for the determination of the depth values. Hence, compared with the case (a) in FIG. 1, the case (b) suffers from an increase in calculation costs (processing amount). Moreover, the case (b) inevitably requires a larger amount of memory to hold the result of the calculation performed to each of the depth values d₁ to d19.

The present invention is conceived in view of the above problems and has an object to provide a three-dimensional image capturing apparatus and a three-dimensional image capturing method to improve a three-dimensional appearance while curbing an increase in calculation cost and easing a cardboard effect.

### Solution to Problem

In order to solve the above problems, a three-dimensional image capturing apparatus according to an aspect of the present invention generates depth information to be used for generating a three-dimensional image from an input image. The three-dimensional image capturing apparatus includes: a capturing unit which obtains the input image in capturing; a designating unit which designates a first object in the input image obtained by the capturing unit; a resolution setting unit which sets depth values, each of which represents a different depth position, as initial depth values so that, in a direction parallel to a depth direction of the input image, depth resolution near the first object is higher than depth resolution positioned apart from the first object, the first object being designated by the designating unit; and a depth information generating unit which generates the depth information corresponding to the input image by determining, for each of two-dimensional regions in the input image, a depth value, from among the depth values set by the resolution setting unit, indicating a depth position corresponding to one of the regions.

The above structure makes it possible to enhance the depth resolution near the designated object, so that more candidates are available for the depth values representing depth positions near the object. Consequently, the three-dimensional image capturing apparatus can ease a cardboard effect of the designated object, and improve the three-dimensional appearance of the object. Here, the three-dimensional image capturing apparatus simply enhances the depth resolution near the object greater than resolution of other regions, which, for example, eliminates the need for increasing the total number of the candidates of the depth values. Consequently, this feature contributes to curbing an increase in calculation cost.

The resolution setting unit may set the initial depth values by shifting at least one of the depth positions close to a depth position of the first object designated by the designating unit.

This feature shifts the predetermined depth positions close to a depth position of the object, which makes it possible to have more candidates for the depth values representing depth positions near the object, and contributes to improving the three-dimensional appearance. Moreover, the feature simply moves the predetermined depth positions and eliminates the need for increasing the number of the depth values, which contributes to curbing an increase in the calculation cost.

The resolution setting unit may further set, as an additional depth value, a new depth value which indicates a depth position that is near the first object and different from the depth positions each indicated in a corresponding one of the initial depth values. The depth information generating unit may determine, for each of the two-dimensional regions in the input image, a depth value from among the initial depth values and the additional depth value.

Since, the additional depth value is set near the object, more candidates are available for the depth values representing depth positions near the object. This feature contributes to further improving the three-dimensional appearance.

The three-dimensional image capturing apparatus may further include: a display unit which displays a stereoscopic effect image showing a stereoscopic effect to be observed when the three-dimensional image is generated based on the input image and the depth information; and a stereoscopic effect adjusting unit which adjusts a level of the stereoscopic effect based on an instruction from a user. In the case where the stereoscopic effect adjusting unit sets the stereoscopic effect to be enhanced, the resolution setting unit may set the additional depth value.

Thus, the additional depth value is set when an instruction is sent from the user, which successfully expresses a three-dimensional appearance which the user desires. Consequently, the feature makes it possible to curb an increase in calculation cost caused by expressing a three-dimensional appearance which the user does not desire.

The three-dimensional image capturing apparatus may further include a three-dimensional image generating unit which generates the three-dimensional image from the input image, based on the input image and the depth information. The display unit may display the three-dimensional image as the stereoscopic effect image.

This feature allows a three-dimensional image to be displayed. Thus, the user can directly check the stereoscopic effect. Since the user can easily adjust the stereoscopic effect, the expressed stereoscopic effect is his or her desired one. Consequently, the feature makes it possible to curb an increase in calculation cost caused by expressing a three-dimensional appearance which the user does not desire.

The designating unit may further additionally designate a second object which is different from the first object and included in the input image obtained by the capturing unit. The resolution setting unit may further set, as an additional depth value, a new depth value which indicates a depth position that is near the second object and different from the depth positions each indicated in a corresponding one of the initial depth values. The depth information generating unit may determine, for each of the two-dimensional regions in the input image, a depth value from among the initial depth values and the additional depth value.

This feature makes it possible to additionally designate another object to enhance the depth resolution near the additionally designated object, which contributes to improving the three-dimensional appearance of the object. For example, this feature makes it possible to additionally designate the second object when the user checks the three-dimensional appearance of the first object set first and then desires to increase the three-dimensional appearance of another object. Consequently, the three-dimensional appearance of the second object, as well as that of the first object, successfully improves.

The designating unit may further additionally designate a second object which is different from the first object and included in the input image obtained by the capturing unit. The resolution setting unit may update the initial depth values by shifting at least one of the depth positions close to a depth position of the second object additionally designated by the designating unit, each of the depth positions being indicated in a corresponding one of the initial depth values.

This feature makes it possible to additionally designate another object to enhance the depth resolution near the additionally designated object, which contributes to improving the three-dimensional appearance of the object. For example, this feature makes it possible to additionally designate the second object when the user checks the three-dimensional appearance of the first object set first and then desires to increase the three-dimensional appearance of another object. Consequently, the three-dimensional appearance of the second object, as well as that of the first object, is successfully improved. Here, the feature simply moves the first-set depth position and eliminates the need for increasing the number of the depth values, which contributes to curbing an increase in calculation cost.

For each of the two-dimensional regions in the input image, the depth information generating unit may: (a) calculate a cost function which corresponds to one of the depth values set by the resolution setting unit, and indicates appropriateness of the corresponding depth value; and (b) determine, as a depth value for a corresponding one of the two-dimensional regions, a depth value corresponding to a cost function whose corresponding depth value is most appropriate.

Hence, the most appropriate depth position is determined based on a cost function obtained for each of the depth values. This feature contributes to determining the most appropriate depth value among candidates for depth values, achieving a better three-dimensional appearance.

The three-dimensional image capturing apparatus may further include a cost function holding unit which holds the cost function calculated by the depth information generating unit.

This feature makes it possible to hold the calculated cost function, which eliminates the need for re-calculating the cost function and contributes to curbing an increase in calculation cost.

For each of the two-dimensional regions in the input image, the cost function holding unit may hold the cost function, calculated by the depth information generating unit, in association with one of the depth values.

Hence, the calculated cost function is held for each of the regions and for each of the depth positions. Thus, when the additional depth value is set, for example, the feature makes it possible to calculate only the cost function corresponding to the additional depth value, and compare the calculated cost function with the held cost function. Consequently, this feature contributes to curbing an increase in calculation cost.

The resolution setting unit may further set, as an additional depth value, a new depth value which indicates a depth position that is near the first object and different from the depth positions each indicated in a corresponding one of the initial depth values. For each of the two-dimensional regions in the input image, the depth information generating unit may further: (a) calculate a cost function which corresponds to the additional depth value; and (b) store the calculated cost function in the cost function holding unit in association with the additional depth value.

Hence, in the case where the additional depth value is set, the feature makes it possible to calculate only the cost function corresponding to the additional depth value, and compare the calculated cost function with the held cost function. This feature contributes to curbing an increase in calculation cost.

For each of the two-dimensional regions in the input image, the cost function holding unit may hold only the cost function, whose corresponding depth value is most appropriate, in association with the most appropriate corresponding depth value.

This feature makes it possible to hold, among calculated cost functions, only the cost function whose depth value is the most appropriate, which contributes to effective use of memory resources.

The resolution setting unit may further set, as an additional depth value, a new depth value which indicates a depth position that is near the first object and different from the depth positions each indicated in a corresponding one of the initial depth values. For each of the two-dimensional regions in the input image, the depth information generating unit may further: (a) calculate a cost function which corresponds to the additional depth value; (b) compare the calculated cost function with the cost function held in the cost function holding unit; and (c) (i) in the case where the calculated cost function is more appropriate than the cost function held in the cost function holding unit, determine that the additional depth value is a depth value for a corresponding one of the two-dimensional regions, and replace the cost function held in the cost function holding unit with the calculated function and (ii) in the case where the cost function held in the cost function holding unit is more appropriate than the calculated cost function, determine that a depth value included in the set depth values and corresponding to the cost function held in the cost function holding unit is a depth value for a corresponding one of the two-dimensional regions.

Hence, in the case where the additional depth value is set, the feature makes it possible to calculate only the cost function corresponding to the additional depth value, and compare the calculated cost function with the held cost function. This feature contributes to curbing an increase in calculation cost.

The three-dimensional image capturing apparatus may further include a display unit which displays the input image so that the first object designated by the designating unit is enhanced.

Hence, the objects designated by the user can be indicated.

It is noted that, instead of being implemented as a three-dimensional image capturing apparatus, the present invention may be implemented as a method including the processing units for the three-dimensional image capturing apparatus as steps. Moreover, the steps may be implemented as a computer-executable program. Furthermore, the present invention may be implemented as a recording medium, such as a computer-readable compact disc-read only memory (CD-ROM) on which the program is recorded, and as information, data, and signals showing the program. Then, the program, the information, and the signals may be distributed via a communications network, such as the Internet.

Part or all of the constituent elements constituting the three-dimensional image capturing apparatus may be configured from a single System-LSI (Large-Scale Integration).The System-LSI is a super-multi-function LSI manufactured by integrating constituent units on one chip. Specifically, the System-LSI is a computer system including a microprocessor, a ROM, a RAM, or by means of a similar device.

### Advantageous Effects of Invention

The present invention successfully improves a three-dimensional appearance while curbing an increase in calculation cost and easing a cardboard effect.

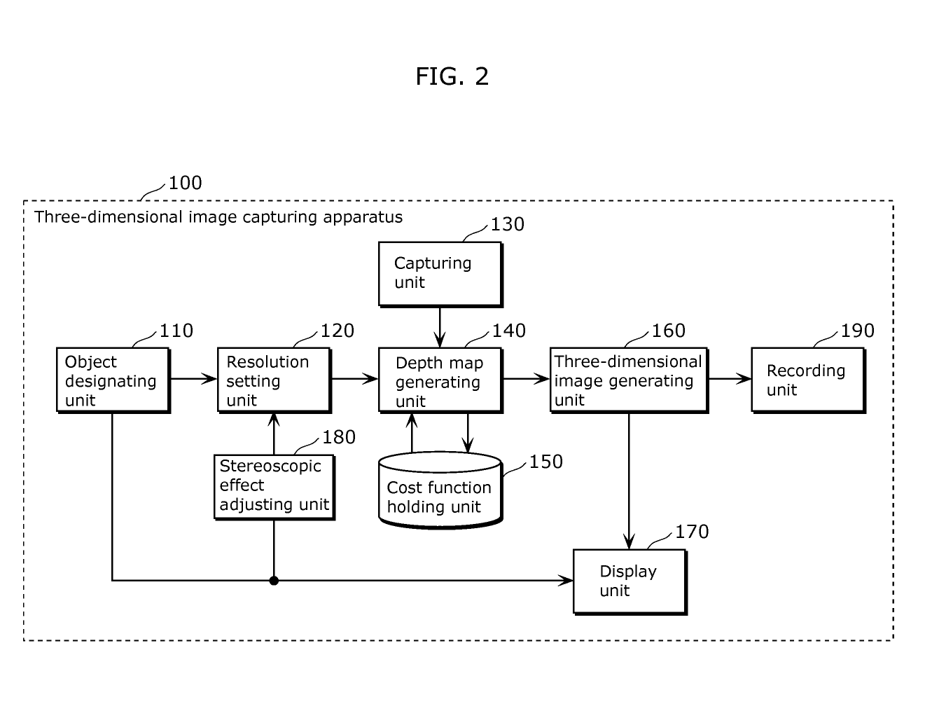

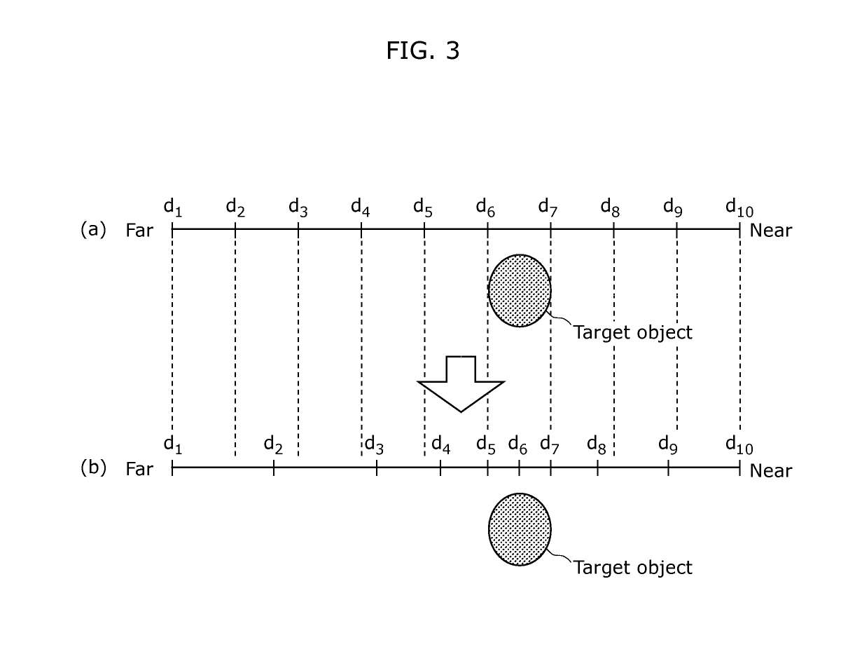

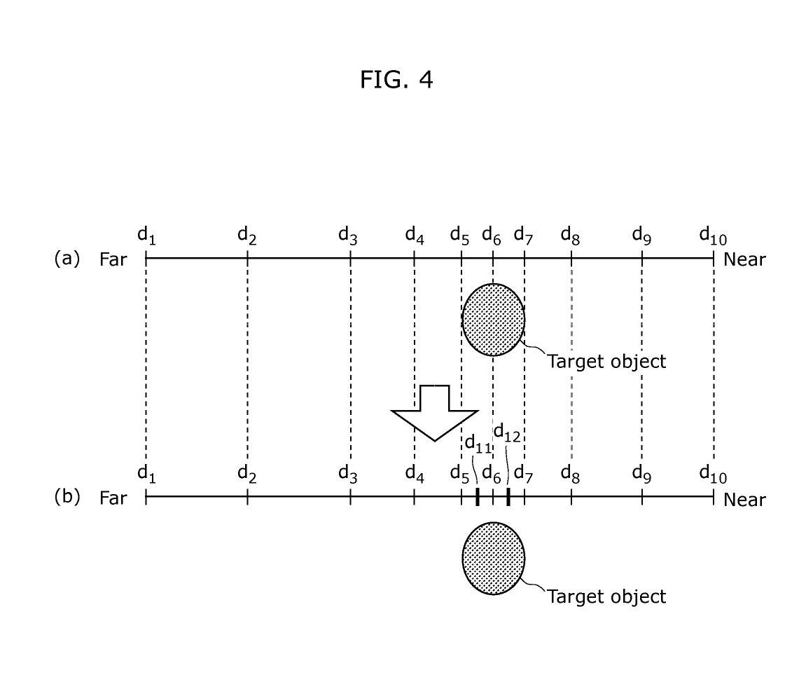

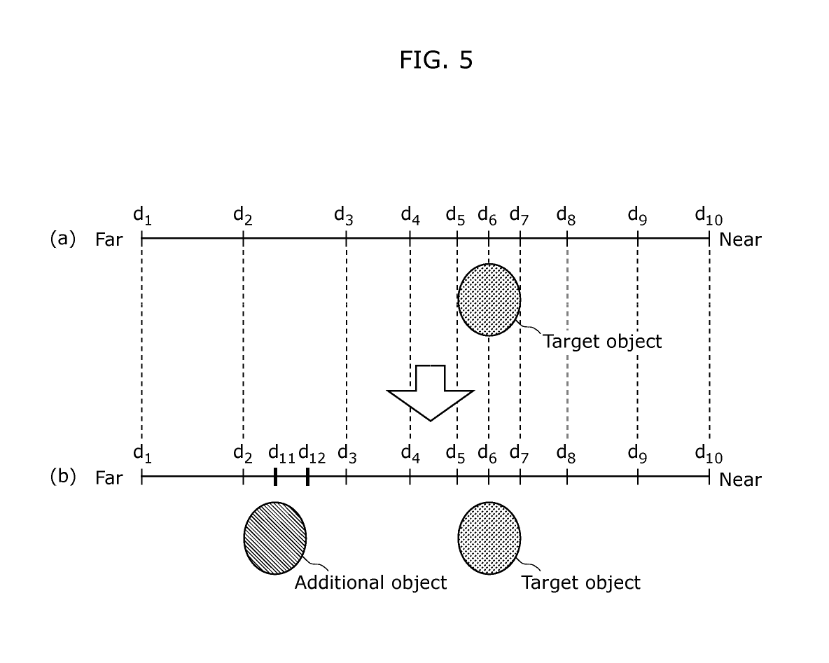

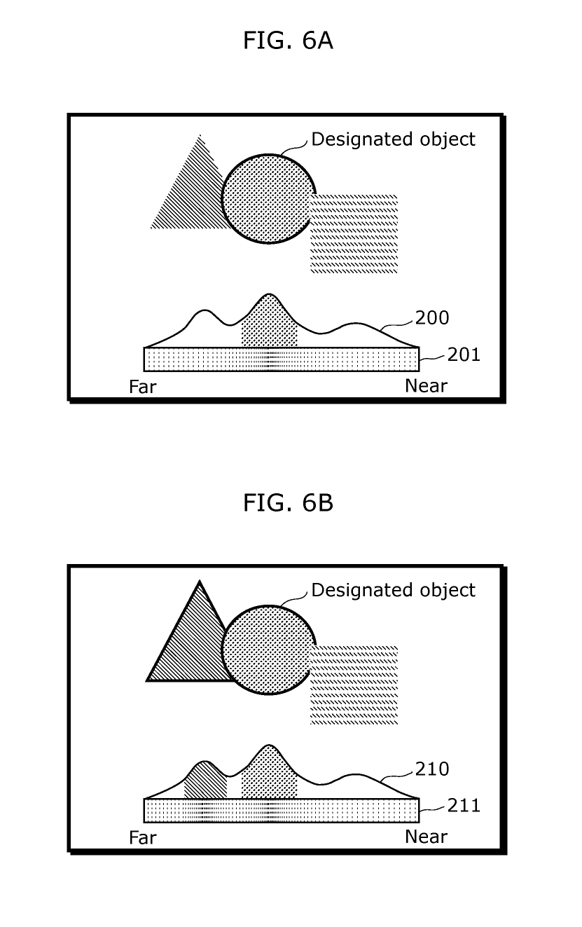

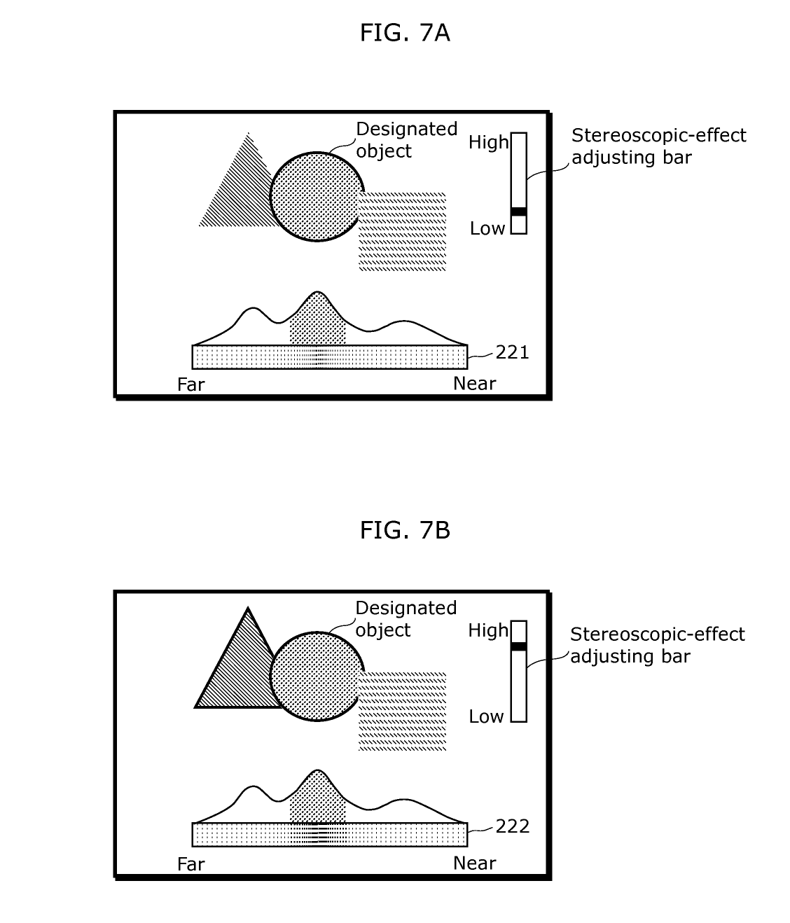

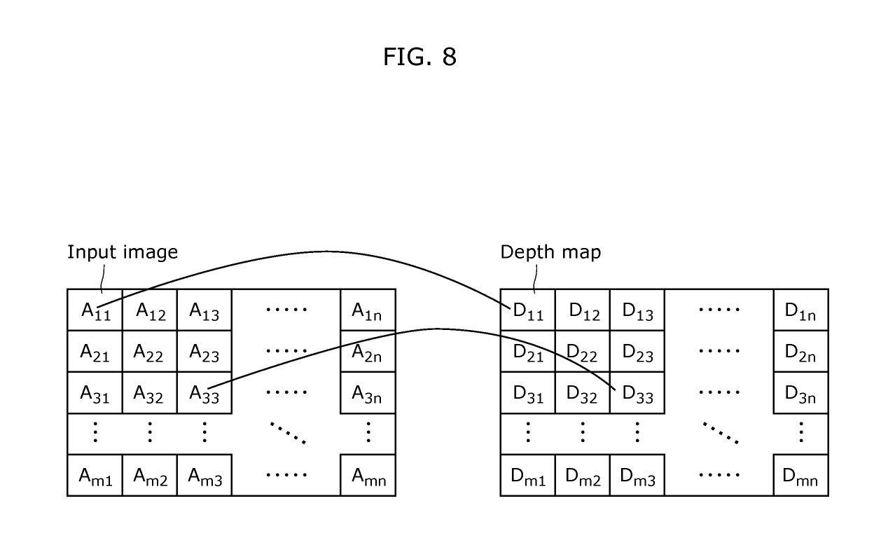

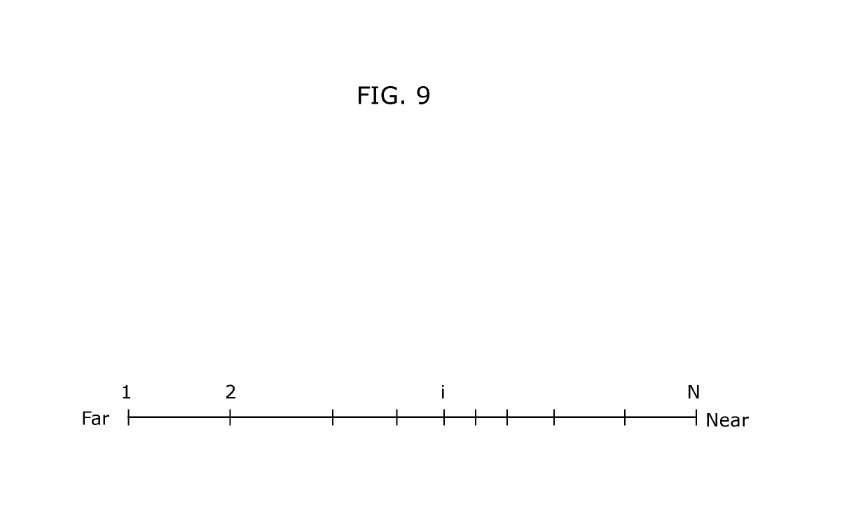

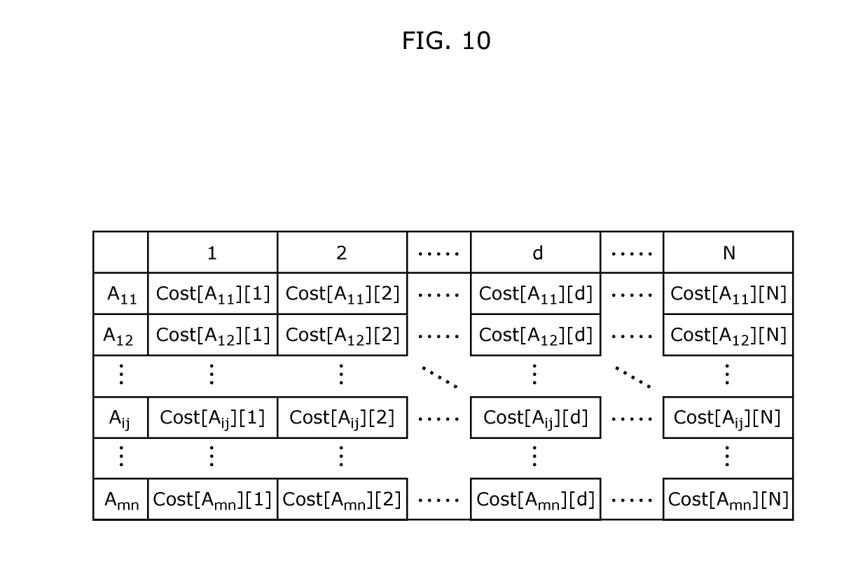

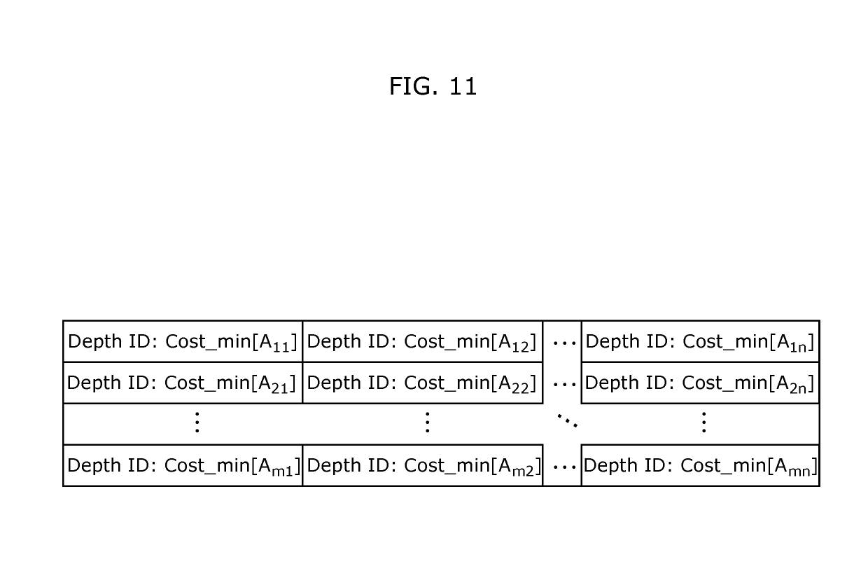

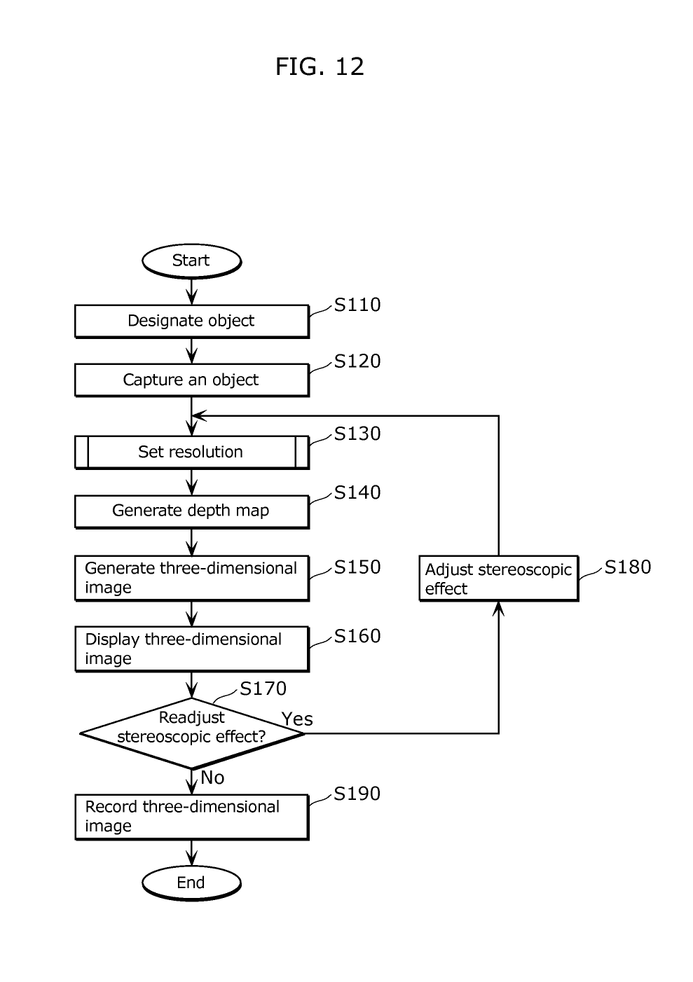

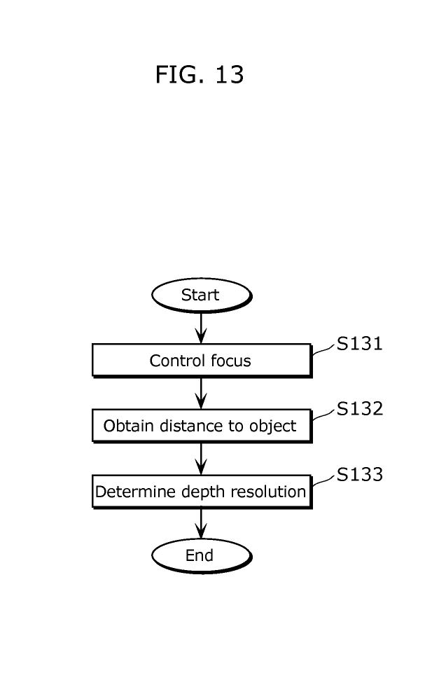

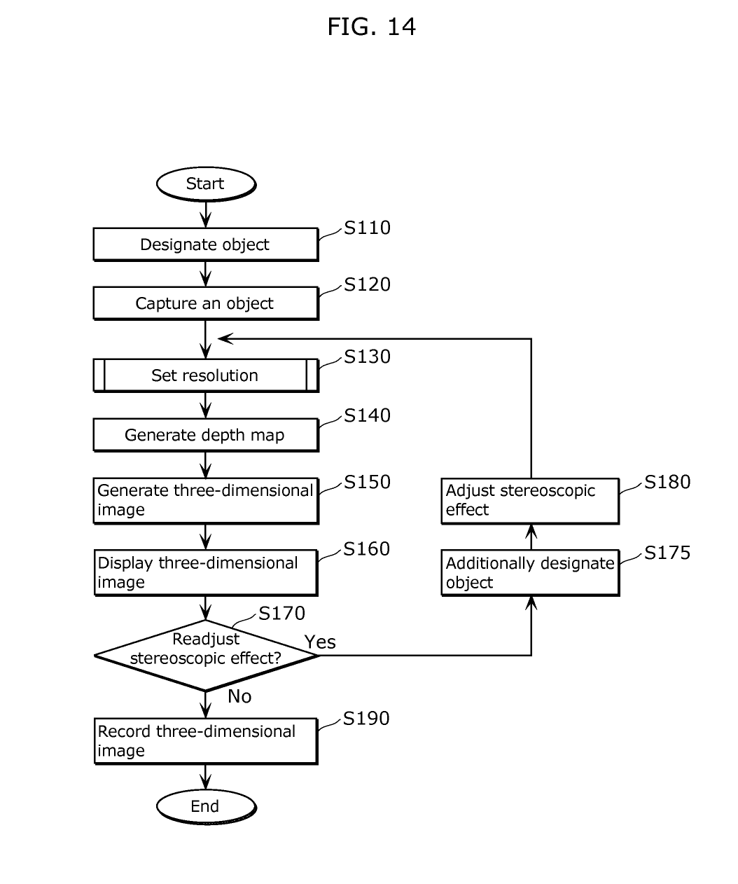

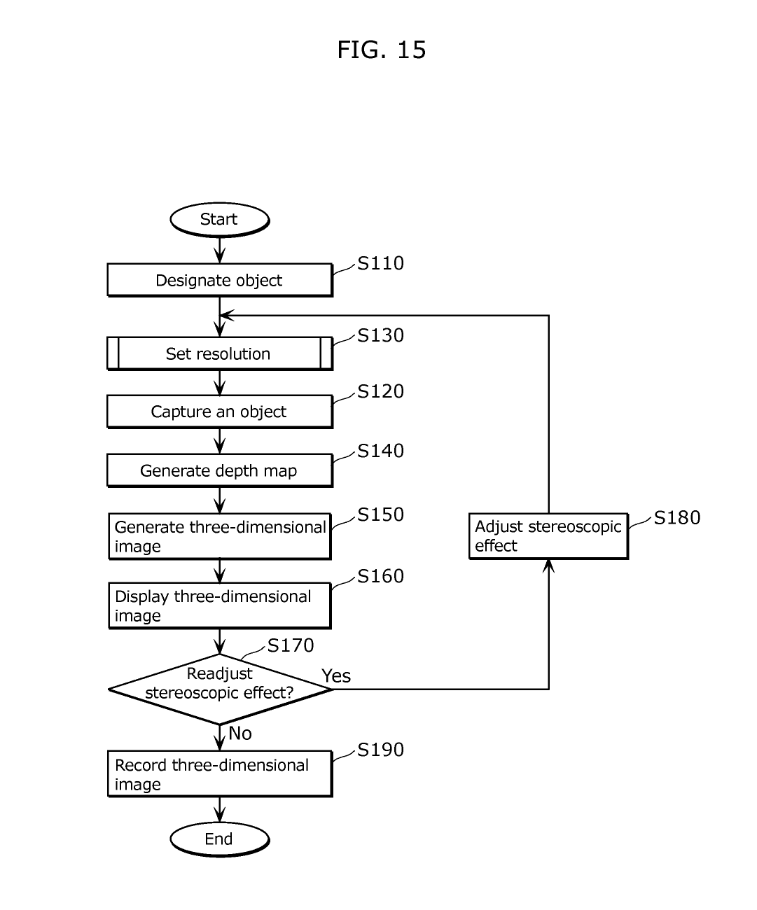

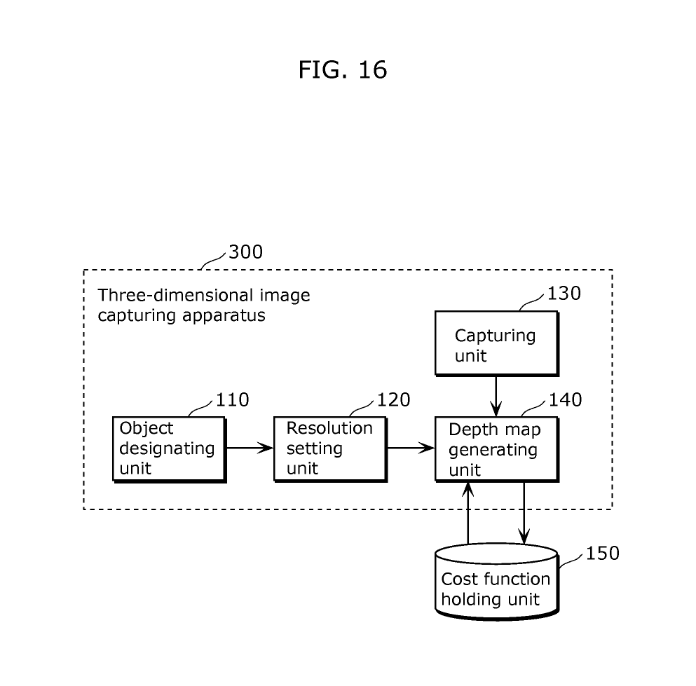

### BRIEF DESCRIPTION OF DRAWINGS

[FIG. 1] FIG. 1 shows a conventional depth resolution.

[FIG. 2] FIG. 2 depicts an exemplary block diagram showing a structure of a three-dimensional image capturing apparatus according to an embodiment of the present invention.

[FIG. 3] FIG. 3 shows exemplary depth resolution according to the embodiment of the present invention.

[FIG. 4] FIG. 4 shows exemplary depth resolution according to the embodiment of the present invention.

[FIG. 5] FIG. 5 shows exemplary depth resolution according to the embodiment of the present invention.

[FIG. 6A] FIG. 6A shows an exemplary user interface used for designating an object according to the embodiment of the present invention.

[FIG. 6B] FIG. 6B shows an exemplary user interface used for designating objects according to the embodiment of the present invention.

[FIG. 7A] FIG. 7A shows an exemplary user interface used for adjusting a stereoscopic effect according to the embodiment of the present invention. [FIG. 7B] FIG. 7B shows an exemplary user interface used for adjusting a stereoscopic effect according to the embodiment of the present invention.

[FIG. 8] FIG. 8 shows an exemplary relationship between an input image and a depth map according to the embodiment of the present invention.

[FIG. 9] FIG. 9 shows an exemplary relationship between depth values and identifiers according to the embodiment of the present invention.

[FIG. 10] FIG. 10 shows exemplary data held in a cost function holding unit according to the embodiment of the present invention.

[FIG. 11] FIG. 11 shows exemplary data held in the cost function holding unit according to the embodiment of the present invention.

[FIG. 12] FIG. 12 depicts a flowchart which shows an exemplary operation of the three-dimensional image capturing apparatus according to the embodiment of the present invention.

[FIG. 13] FIG. 13 depicts a flowchart which exemplifies setting of the depth resolution according to the embodiment of the present invention.

[FIG. 14] FIG. 14 depicts a flowchart which shows another exemplary operation of the three-dimensional image capturing apparatus according to the embodiment of the present invention.

[FIG. 15] FIG. 15 depicts a flowchart which shows another exemplary operation of the three-dimensional image capturing apparatus according to the embodiment of the present invention.

[FIG. 16] FIG. 16 depicts an exemplary block diagram showing a structure of a three-dimensional image capturing apparatus according to a modification in the embodiment of the present invention.

### DESCRIPTION OF EMBODIMENT

### Embodiment

Described hereinafter are a three-dimensional image capturing apparatus and a three-dimensional image capturing method according to an embodiment of the present invention, with reference to the drawings. It is noted that the embodiment below is a specific example of the present invention. The numerical values, shapes, materials, constitutional elements, arrangement positions and connecting schemes of the constitutional elements, steps, and an order of steps are examples, and shall not be defined as they are.

The present invention shall be defined only by claims. Hence, among the constitutional elements in the embodiment, those not described in an independent claim, which represents the most generic concept of the present invention, are not necessarily required to achieve the objects of the present invention. However, such constitutional elements are introduced to implement a preferable form of the present invention.

The three-dimensional image capturing apparatus according to the embodiment of the present invention includes: a capturing unit which obtains an input image in capturing; a designating unit which designates an object in the input image; a resolution setting unit which sets depth values each representing a different depth position, so that depth resolution near the designated object is higher; and a depth information generating unit which generates depth information that corresponds to the input image, by determining, for each of regions in the input image, a depth value, from among the set depth values, indicating a depth position corresponding to one of the regions.

FIG. 2 depicts an exemplary block diagram showing a structure of a three-dimensional image capturing apparatus 100 according to the embodiment of the present invention. The three-dimensional image capturing apparatus 100 generates depth information (depth map) to be used for generating a three-dimensional image out of a two-dimensional input image.

As shown in FIG. 2, the three-dimensional image capturing apparatus 100 includes: an object designating unit 110, a resolution setting unit 120, a capturing unit 130, a depth map generating unit 140, a cost function holding unit 150, a three-dimensional image generating unit 160, a display unit 170, a stereoscopic effect adjusting unit 180, and a recording unit 190.

The object designating unit 110 designates an object (target object) in an input image obtained by the capturing unit 130. The object designating unit 110 may designate two or more objects. The object designating unit 110 designates an object designated by the user via, for example, a user interface. Specifically, the object designating unit 110 designates the user-designated object via the user interface displayed on the display unit 170 and used for receiving the designation by the user.

The object designating unit 110 may also perform image recognition processing on the input image to specify a designated region, and designate the specified designated region as the target object. The image recognition processing includes, for example, facial recognition processing and edge detection processing. The object designating unit 110 may perform facial recognition processing on the input image to specify a face region of a person, and designate the specified face region as the target object.

Furthermore, the object designating unit 110 may additionally designate a second object which differs from the object designated first (first object). Here, the object designating unit 110 may designate two or more second objects.

Here, when the second object is designated, the first object has already been subject to processing for enhancing depth resolution, and the second object has not been subject to processing for enhancing depth resolution yet. Specifically, after the user confirms the stereoscopic effect observed after the depth-resolution-enhancing processing performed on the first object; that is after the depth map is generated once, the object designating unit 110 additionally designates a newly-designated object as the second object.

The resolution setting unit 120 performs processing for enhancing the depth resolution of the object designated by the object designating unit 110. Specifically, the resolution setting unit 120 sets multiple depth values each representing a different depth position, so that, in a direction parallel to a depth direction of the input image, depth resolution near the object designated by the object designating unit 110 is higher than depth resolution positioned apart from the object.

It is noted that the depth direction is perpendicular to a two-dimensional input image. In other words, the depth direction is a front-back direction in the two-dimensional input image; that is, a direction from a display toward the user (or a direction from the user toward the display). Furthermore, a region near the object in the depth direction includes the object and a region surrounding (around) the object in the depth direction.

The depth resolution is a value indicating how depth positions, which are different from each other, vary. Specifically, the depth resolution is higher as a density of the depth positions is higher, and the depth resolution is lower as a density of the depth positions is lower. In other words, the depth resolution is higher as more depth positions are observed in a predetermined region in the depth direction. The depth resolution is lower as fewer depth positions are observed in the predetermined region.

It is noted that a detailed operation of the resolution setting unit 120 shall be described later with reference to FIGS. 3 to 5.

The capturing unit 130 obtains an input image in capturing. The capturing unit 130 includes an optical system such as a lens, and an imaging device which converts incident light into electric signals (input image).The capturing unit 130 moves at least one of the lens and the imaging device to change the distance between the lens and the imaging device so as to shift the focus (focal point).

It is noted that the depth map generating unit 140 employs techniques such as the Depth from Defocus (DFD) and the Depth from Focus (DFF) to determine a depth value. Depending on the techniques, the capturing unit 130 changes how to obtain an input image.

In the DFD, for example, the capturing unit 130 shifts the focus (focal point) and performs capturing multiple times in order to obtain an input image for each of focal points. For example, the capturing unit 130 obtains two input images: one of which is the farthest-end image captured at the longest focal length (farthest end), and the other one of which is the nearest-end image captured at the shortest focal length (nearest end).

In the DFF (focal stacking), for example, the capturing unit 130 shifts the focal point and performs capturing multiple times in order to obtain an input image for each of focal points. Here, the capturing unit 130 obtains as many input images as the number of depth values. In other words, the capturing unit 130 performs capturing using each of depth positions indicated by the depth values as a focal point in order to obtain input images each corresponding to one of the depth positions.

It is noted that a technique for the depth map generating unit 140 to determine depth values shall not be limited to the DFD or the DFF; instead, other techniques may be employed to determine a depth.

As an exemplary depth information generating unit, the depth map generating unit 140 generates two-dimensional depth information (depth map) corresponding to the input image, by determining, for each of two-dimensional regions in the input image, a depth position, from among the depth values set by the resolution setting unit 120, corresponding to one of the regions. Here, each of the two-dimensional regions in the input image includes one or more pixels.

For example, for each of the two-dimensional regions in the input image, the depth map generating unit 140 calculates a cost function which (i) corresponds to one of the depth values set by the resolution setting unit 120 and (ii) indicates the validity of the corresponding depth value. Then, the depth map generating unit 140 determines, as a depth value for the corresponding one of the two-dimensional regions, one of the depth values corresponding to a cost function indicating that the depth value is most appropriate. Here, the cost function is included in the calculated cost functions for the two-dimensional regions. The operation of the depth map generating unit 140 shall be detailed later.

The cost function holding unit 150 is a memory to hold the cost functions calculated by the depth map generating unit 140. The data held in the cost function holding unit 150 shall be detailed later.

Based on the input image and the depth map, the three-dimensional image generating unit 160 generates a three-dimensional image from the input image. It is noted that the input image used here does not have to be identical to the image used for generating the depth map. The three-dimensional image includes, for example, a left-eye image and a right-eye image having parallax. The viewer (user) watches the left-eye image with the left eye and the right-eye image with the right eye so that the user can spatially see the three-dimensional image.

Specifically, for each of two-dimensional regions in the input image, the three-dimensional image generating unit 160 generates parallax information based on a depth value corresponding to the region. The parallax information indicates parallax between the left-eye image and the right-eye image. For example, the parallax information indicates an amount (number of pixels) in which the corresponding region is to be horizontally shifted. The three-dimensional image generating unit 160 horizontally shifts the corresponding region to generate the left-eye image and the right-eye image.

Based on the input image and the depth map, the display unit 170 displays a stereoscopic effect image indicating a stereoscopic effect to be observed when a three-dimensional image is generated.

The stereoscopic effect image is generated by the stereoscopic effect adjusting unit 180. The stereoscopic effect image may also be a three-dimensional image generated by the three-dimensional image generating unit 160.

Furthermore, the display unit 170 displays a graphical user interface (GUI). The GUI is an interface used for, for example, receiving from the user designation of an object and adjusting the level of the stereoscopic effect. A specific example of the GUI shall be described later.

Based on the instruction from the user, the stereoscopic effect adjusting unit 180 adjusts the level of the stereoscopic effect. Specifically, the stereoscopic effect adjusting unit 180 receives the instruction from the user via the GUI displayed on the display unit 170 for adjusting the stereoscopic effect. Here, the stereoscopic effect adjusting unit 180 may generate a stereoscopic image showing a stereoscopic effect to be observed when a three-dimensional image is generated from the input image so that the user can check the stereoscopic effect.

For example, the stereoscopic effect adjusting unit 180 receives from the user an instruction indicating to what level the stereoscopic effect is to be enhanced or reduced. In other words, the stereoscopic effect adjusting unit 180 receives from the user an instruction to indicate an object whose stereoscopic effect is to be adjusted and the level of stereoscopic effect. The received instruction is sent to the resolution setting unit 120.

The recording unit 190 records on a recording medium the three-dimensional images, such as the left-eye image and the right-eye image, generated by the three-dimensional image generating unit 160. The recording unit 190 may also record the input image obtained by the capturing unit 130 and the depth map generated by the depth map generating unit 140. It is noted that the recording medium is such as an internal memory included in the three-dimensional image capturing apparatus 100 and a memory card for the three-dimensional image capturing apparatus 100.

Described next is how to set the depth resolution according to the embodiment of the present invention.

FIG. 3 shows exemplary depth resolution according to the embodiment of the present invention.

The illustration (a) in FIG. 3 shows that, as shown in the illustration (a) in FIG. 1, 10 depth values d₁ to d₁₀ are predetermined between the farthest end (longest focal length) and the nearest end (shortest focal length) of the three-dimensional image capturing apparatus 100 (camera). In other words, the three-dimensional image capturing apparatus 100 according to the embodiment has the predetermined number of depth values. The example in (a) in FIG. 3 shows 10 depth values.

Here, the object designating unit 110 designates, as a target object, an object found between the depth positions indicated by the depth values d₆ and d₇. The resolution setting unit 120 brings at least one of the 10 depth positions close to a depth position near the target object to set 10 depth values d₁ to d₁₀ as shown in (b) in FIG. 3.

Specifically, the resolution setting unit 120 adjusts previously equally-spaced depth values so that, as the depth values are located farther away from the target object with the target object centered, the neighboring depth values are widely spaced. In other words, the resolution setting unit 120 sets multiple depth values so that the depth values near the target object are narrowly spaced. Such a setting enhances the depth resolution near the target object.

In other words, the resolution setting unit 120 sets multiple depth values so that more depth values are included in a region near the target object than in a region away from the target object (such as a region near the longest focal length or the shortest focal length). The resolution setting unit 120 sets multiple depth values so that the depth values nearer the target object are denser.

Hence, the example in (a) in FIG. 3 shows that the depth values of the target object are represented only by two of the values d₆ and d₇. In contrast, the example in (b) in FIG. 3 shows that the depth values of the target object are represented by three of the values d₅, d₆, and d₇. Compared with the case (a) in FIG. 3, the case (b) in FIG. 3 successfully shows an improved three-dimensional appearance. Here, the number of the overall depth values remains 10, and the calculation cost for determining the depth values also remains unchanged. Thus, the case (b) also shows a reduction in a calculation cost increase.

Hence, the resolution setting unit 120 sets the depth values by shifting at least one of the depth positions to a depth position near the object designated by the object designating unit 110. This feature makes it possible to have more candidates for the depth values representing depth positions near the object, which contributes to improving the three-dimensional appearance. Moreover, in the feature, the predetermined depth positions are simply moved and there is no need for increasing the number of the depth values, which contributes to reducing an increase in the calculation cost.

It is noted that the setting of the depth resolution is preferably executed when the object is designated to the input image for the first time; that is, when a first object at first is designated. In other words, the resolution setting unit 120 sets the initial depth values by shifting at least one of the predetermined depth positions close to a depth position near the first object designated first by the object designating unit 110. The initial depth values are d1 to d10 shown in (b) in FIG. 3. They are depth values which have received the processing for enhancing the depth resolution at least once.

FIG. 4 shows exemplary depth resolution according to the embodiment of the present invention.

The illustration (b) in FIG. 4 shows additional new depth values d₁₁ and d₁₂ near the target object. In other words, the resolution setting unit 120 sets, as additional depth values, the new depth values d₁₁ and d₁₂ that indicate depth positions. The depth positions are near the target object and different from the depth positions each indicated in a corresponding one of the initial depth values d₁ to d₁₀ shown in (b) in FIG. 3. Here, for each of two-dimensional regions in an input image, the depth map generating unit 140 determines a depth value from among the initial depth values d₁ to d₁₀ and the additional depth values d₁₁ and d₁₂.

Since the resolution setting unit 120 sets the additional depth values near the object, more candidates are available for the depth values representing depth positions near the object. Such a feature can further enhance the depth resolution and the three-dimensional appearance for the target object.

It is noted that an additional depth value is preferably set after the setting of the initial depth values and the generation of the depth map. Specifically, once the initial depth values have set, the depth map generating unit 140 generates the depth map based on the set initial depth values. Then, based on the generated depth map and the input image, the display unit 170 displays a stereoscopic effect image as well as a GUI which receives from the user an instruction for adjusting the level of the stereoscopic effect.

Upon receiving from the user the instruction for enhancing the stereoscopic effect via the GUI displayed on the display unit 170, the stereoscopic effect adjusting unit 180 notifies the resolution setting unit 120 of the instruction. When the stereoscopic effect adjusting unit 180 sets the stereoscopic effect to be enhanced, the resolution setting unit 120 sets an additional depth value. This feature makes it possible to additionally designate the second object when the user checks the three-dimensional appearance of the first object set first and then desires to increase the three-dimensional appearance of another object. Consequently, the three-dimensional appearance of the second object, as well as that of the first object, is successfully improved.

Here, cost functions which correspond to the initial depth values have already been calculated. Thus, the depth map generating unit 140 may calculate only a cost function which corresponds to the additional depth value. In other words, there is no need to recalculate the cost functions that correspond to the already-set initial depth values. This feature contributes to minimize an inevitable rise in calculation cost to increase the stereoscopic effect.

FIG. 5 shows exemplary depth resolution according to the embodiment of the present invention.

In the embodiment, as described above, the object designating unit 110 can additionally designate the second object that differs from the first object. FIG. 5 shows exemplary depth resolution when the second object is additionally designated.

The resolution setting unit 120 sets new depth values (additional depth values d₁₁ and d₁₂) that indicate depth positions. The depth positions are near the additional object and different from the depth positions each indicated in a corresponding one of the initial depth values d₁ to d₁₀. Here, for each of two-dimensional regions in an input image, the depth map generating unit 140 determines a depth value from among the initial depth values d₁ to d₁₀ and the additional depth values d₁₁ and d₁₂.

This feature makes it possible to enhance the depth resolution for the newly designated additional object, as well as that for the target object, and contributes to improving the three-dimensional appearance of the target object and the additional object.

It is noted that the second object may be preferably added after the setting of the initial depth values and the generation of the depth map. Specifically, once the initial depth values have set, the depth map generating unit 140 generates the depth map based on the set initial depth values. Then, based on the generated depth map and the input image, the display unit 170 displays a stereoscopic effect image as well as a GUI which receives from the user an instruction for adjusting the level of the stereoscopic effect.

Upon receiving from the user the instruction for designating the second object via the GUI displayed on the display unit 170, the object designating unit 110 additionally designates the second object. When the second object is additionally designated, the resolution setting unit 120 sets a depth value so that the depth resolution for the second object increases. This feature makes it possible to enhance the depth resolution for the new and additionally-designated second object, as well as that for the first object designated first, and contributes to improving the three-dimensional appearance for the first and second objects.

Described next is an exemplary GUI displayed on the display unit 170 according to the embodiment of the present invention.

FIG. 6A shows an exemplary user interface used for designating an object according to the embodiment of the present invention.

As shown in FIG. 6A, the display unit 170 displays an input image so that the object designated by the object designating unit 110 is enhanced. Techniques to enhance the object include, for example, the ones to make the object outline bold, to display the object with a highlighter setting, or to highlight the object with an inverted color.

Furthermore, the display unit 170 displays a histogram 200 indicating a depth position of the object. The vertical axis of the histogram 200 indicates the number of pixels. The example in FIG. 6A shows a designated object found approximately in the middle in the depth direction.

Moreover, the display unit 170 displays a stereoscopic effect image 201 indicating a stereoscopic effect. The example in FIG. 6A shows that the stereoscopic effect image 201 indicates the stereoscopic effect with a shading pattern. Specifically, a region having darker shading indicates a stronger stereoscopic effect; that is, the density of the depth values is higher. A region having lighter shading indicates a reduced stereoscopic effect; that is, the density of the depth values is lower. In the embodiment, as shown in FIG. 6A, enhanced is a stereoscopic effect for the region including the designated object.

Here, the display unit 170 displays, for example, a cursor so that the object designating unit 110 can receive, from the user, an instruction for designating an object. For example, when the user encloses a predetermined region in an image displayed on the display unit 170, the object designating unit 110 extracts an object included in the region, and designates the extracted object. Alternatively, the object designating unit 110 may designate the predetermined region itself as an object. The object included in the region may be extracted by image processing such as edge detection processing, facial recognition processing, and color detection processing.

FIG. 6B shows an exemplary user interface used for designating objects according to the embodiment of the present invention.

As shown in FIG. 6B, the display unit 170 displays an input image, enhancing the objects designated by the object designating unit 110. Hence, the objects designated by the user can be indicated. Techniques to enhance the objects include, for example, the ones to make the object outline bold, to display the object with a highlighter setting, or to highlight the object with an inverted color. Here, how to enhance the objects may be changed between the first object designated first and the second object designated second and the following. The example in FIG. 6B shows that a different object has a different gradation.

As shown in FIG. 6A, the display unit 170 displays a histogram 210 indicating depth positions of the objects. The example in FIG. 6B shows that the first object is designated approximately in the middle in the depth direction and the second object is additionally designated at a far end in the depth direction.

When the second object is additionally designated, the resolution setting unit 120 sets an additional depth value near the additional object (second object) as shown in (b) in FIG. 5 so as to enhance the depth resolution for the additional object. Hence, the stereoscopic effect near the second object, as well as that near the first object, is successfully enhanced.

Moreover, the display unit 170 displays a stereoscopic effect image 211 indicating a stereoscopic effect. As the stereoscopic effect image 201 in FIG. 6A indicates, the stereoscopic effect image 211 indicates the stereoscopic effect with a shading pattern. The example in FIG. 6B shows that the stereoscopic effects are enhanced near the first and second objects.

Thus, an additional depth value is set upon receiving an instruction from the user, which successfully expresses a three-dimensional appearance which the user desires. Consequently, the feature makes it possible to curb an increase in calculation cost caused by expressing a three-dimensional appearance of the user's desire.

FIGS. 7A and 7B show exemplary user interfaces used for adjusting a stereoscopic effect according to the embodiment of the present invention.

The examples in FIGS. 7A and 7B show a stereoscopic-effect adjusting bar in the displays. The user operates the stereoscopic-effect adjusting bar to adjust the level of the stereoscopic effect.

When the user reduces the stereoscopic effect as shown in FIG. 7A, for example, the stereoscopic effect adjusting unit 180 generates the stereoscopic effect image 211 indicating a reduced stereoscopic effect for the designated object. Since, the stereoscopic effect image indicates the stereoscopic effect with a shading pattern, the stereoscopic effect adjusting unit 180 generates the stereoscopic effect image 211 showing the designated object in a lightened color.

Furthermore, the stereoscopic effect adjusting unit 180 sets the stereoscopic effect to be reduced based on an instruction from the user. Then, when the stereoscopic effect is set to be reduced, the resolution setting unit 120 can reduce the stereoscopic effect by, for example, widening the space between the depth positions near the target object among depth positions indicated in initial depth values. For example, the resolution setting unit 120 updates the depth values so that the space between the depth positions near the target object is wider as the stereoscopic effect is reduced.

The resolution setting unit 120 may also delete, among initial depth values, an initial depth value which indicates a depth position near the target object. For example, the resolution setting unit 120 sets more depth values to-be-deleted near the target object as the stereoscopic effect is reduced. This feature also contributes to reducing the stereoscopic effect.

In contrast, when the user enhances the stereoscopic effect, as shown in FIG. 7B, the stereoscopic effect adjusting unit 180 generates a stereoscopic effect image 222 indicating an enhanced stereoscopic effect for the designated object. Specifically, the stereoscopic effect adjusting unit 180 generates the stereoscopic effect image 222 showing the designated object in a darkened color.

Furthermore, the stereoscopic effect adjusting unit 180 sets the stereoscopic effect to be enhanced based on an instruction from the user. Then, when the stereoscopic effect is set to be enhanced, the resolution setting unit 120 can enhance the stereoscopic effect by, for example, narrowing the space between the depth positions near the target object among depth positions indicated in initial depth values. For example, the resolution setting unit 120 updates the depth values so that the space between the depth positions near the target object is narrower as the stereoscopic effect is enhanced.

The resolution setting unit 120 may also set the additional depth value near the target object as shown in (b) in FIG. 4. For example, the resolution setting unit 120 sets more additional depth values near the target object as the stereoscopic effect is enhanced.

This feature also contributes to enhancing the stereoscopic effect.

Described next is an example of how to generate the depth map according to the embodiment of the present invention.

FIG. 8 shows an exemplary relationship between an input image and a depth map (depth information) according to the embodiment of the present invention.

The input image includes pixels A₁₁ to Aₘₙ arranged in an m×n matrix.

The depth map is an example of the depth information, and shows a depth value for each of two-dimensional regions included in the input image. The example in FIG. 8 illustrates that the depth map shows a depth value for each of pixels included in the input image. In other words, the pixels in the input image and the pixels in the depth map correspond to each other on one-on-one basis. Specifically, the depth value Dᵢⱼ corresponds to the pixel Aᵢⱼ in the input image. Here, i is 1≦i≦m, and j is 1≦i≦n.

FIG. 9 shows an exemplary relationship between depth values and identifiers according to the embodiment of the present invention.

The resolution setting unit 120 assigns an identifier to each of the set depth values. The example in FIG. 9 shows that, in setting n depth values, the resolution setting unit 120 assigns an identifier “1” to the farthest depth value from the camera and an identifier “N” to the nearest depth value to the camera.

It is noted that how to assign an identifier shall not be limited to this; instead, the resolution setting unit 120 may assign, for example, the identifier “N” to the farthest depth value from the camera and the identifier “1” to the nearest depth value to the camera. Instead of assigning an identifier, the resolution setting unit 120 may use a depth value itself as an identifier.

FIG. 10 shows exemplary data held in the cost function holding unit 150 according to the embodiment of the present invention.

For each of the two-dimensional regions in the input image, the depth map generating unit 140 calculates a cost function corresponding to one of the depth values, and stores the calculated cost function in the cost function holding unit 150. Specifically, for each of the two-dimensional regions in the input image, the cost function holding unit 150 holds the cost function, calculated by the depth map generating unit 140, in association with one of the depth values. Since the cost function holding unit 150 holds the calculated cost functions, the depth map generating unit 140 does not have to recalculate the cost functions and contributes to reducing an increase in calculation cost.

The example in FIG. 10 shows that the cost function holding unit 150 holds cost functions corresponding to (i) the identifiers “1” to “N” and (ii) the pixels A₁₁ to Aₘₙ in the input image. Here, each of the identifiers “1” to “N” corresponds to one of the depth values set by the resolution setting unit 120. Specifically, first, the depth map generating unit 140 calculates the cost function Cost[Aᵢⱼ][d] that corresponds to both of the identifier “d” and the pixel Aᵢⱼ. Then, the depth map generating unit 140 holds the calculated cost function Cost[Aᵢⱼ][d] in the cost function holding unit 150.

Described here is how specifically a cost function is calculated.

Described first is, using the DFD, how to calculate a cost function when the farthest-end image and the nearest-end image are obtained as input images. It is noted that the details of the calculation are disclosed in Non Patent Literature 1 “Coded Aperture Pairs for Depth from Defocus (Changyin Zhou, Stephen Lin, Shree Nayer)”.

A cost function is expressed by the following Expression 1:

$$\begin{matrix}[ Math . 1 ] & \\ E ( \hat{d} \vert {F}_{1} , {F}_{2} , σ ) = {min}_{{\hat{F}}_{0}} {\sum }_{i = 1 , 2} {‖ {\hat{F}}_{0} \cdot {K}_{i}^{\hat{d}} - {F}_{i} ‖}^{2} + {‖ C \cdot {\hat{F}}_{0} ‖}^{2} & ( Expression 1 )\end{matrix}$$

Here, F₁ and F₂ are frequency coefficients obtained by frequency-transforming two different blurred images. Specifically, F₁ is a frequency coefficient obtained by frequency-transforming the nearest-end image, and F₂ is a frequency coefficient obtained by frequency-transforming the farthest-end image.

In addition, Kᵢ^{d} is an optical transfer function (OTF) obtained by frequency-transforming a point spread function (PSF). The depth map generating unit 140 holds in the internal memory a PSF or an OTF corresponding to a focal point. For example, K₁^{d} is an OTF corresponding to F₁; namely, the nearest-end image, and K₂^{d} is an OTF corresponding to F₂; namely, the farthest-end image.

F₀ is expressed by Expression 2 below. Here, C is an adjustment coefficient to reduce noise:

$$\begin{matrix}[ Math . 2 ] & \\ {\hat{F}}_{0} = \frac{{F}_{1} \cdot {\overline{K}}_{1}^{\hat{d}} + {F}_{2} \cdot {\overline{K}}_{2}^{\hat{d}}}{{\vert {K}_{1}^{\hat{d}} \vert}^{2} + {\vert {K}_{2}^{\hat{d}} \vert}^{2} + {\vert C \vert}^{2}} & ( Expression 2 )\end{matrix}$$

Here, K is a complex conjugate of K. After calculating the right term of Expression 1, the depth map generating unit 140 transforms the calculated result into a special domain by inverse frequency transformation. Then, for each of the pixels, the depth map generating unit 140 determines the depth value d having the smallest cost function. It is noted that the cost function represented by Expression 1 shows that the depth value is more appropriate as the value of the cost function is smaller. In other words, the depth value having the smallest cost function is the most appropriate depth value, and the depth value indicates a depth position of the pixel corresponding to the depth value itself.

In the case where an all-focus image is obtained as the input image, the depth map generating unit 140 can calculate a cost function based on a PSF, as described above, to determine the cost function showing the most appropriate depth value.

Hence, the depth map generating unit 140 determines the most appropriate depth position based on a cost function obtained for each of the depth values. This feature contributes to determining the most appropriate depth value among candidates for depth values, and improving a three-dimensional appearance.

Described next is how to calculate a cost function, using the DFF. Here, obtained as input images are images each focused at a depth position indicated in depth values set by the resolution setting unit 120.

The depth map generating unit 140 calculates a contrast for each of the regions in an input image. Specifically, for each of the pixels, the depth map generating unit 140 determines, as a depth value for the pixel, a depth position which corresponds to an input image having the highest contrast among the input images. In other words, the highest contrast denotes the cost function indicating the most appropriate depth value.

It is noted that in the case where (i) a cost function corresponding to an initial depth value has already been calculated and is held in the cost function holding unit 150 and (ii) a new depth value is additionally set by the resolution setting unit 120, the depth map generating unit 140 may only calculate a cost function corresponding to the new additional depth value (additional depth value). Then, the depth map generating unit 140 may store in the cost function holding unit 150 the calculated cost function in association with the additional depth value. Thus, in the case where the additional depth value is set, the depth map generating unit 140 may calculate only a cost function corresponding to an additional depth value and compare the calculated cost function with the held cost function. This feature successfully curbs an increase in calculation cost.

Moreover, for each of the two-dimensional regions in an input image, the cost function holding unit 150 may hold only the cost function indicating that the corresponding depth value is the most appropriate, in association with the most appropriate corresponding depth value. A specific example of the feature is shown in FIG. 11.

FIG. 11 shows exemplary data held in the cost function holding unit 150 according to the embodiment of the present invention. For example, FIG. 11 shows that, for each of the pixels in an input image, the cost function holding unit 150 holds the identifiers (depth ID) shown in FIG. 9 in association with smallest values Cost_min for cost functions.

It is noted that in the case where (i) a cost function corresponding to an initial depth value has already been calculated and the smallest value of the calculated cost function is held in the cost function holding unit 150 and (ii) a new depth value is additionally set by the resolution setting unit 120, the depth map generating unit 140 may only calculate a cost function corresponding to the new additional depth value (additional depth value). Then, the depth map generating unit 140 compares the calculated cost function with the cost function held in the cost function holding unit 150.

In the case where the calculated cost function is more appropriate than the cost function held in the cost function holding unit 150, the depth map generating unit 140 determines that the additional depth value is the depth value for a corresponding one of the two-dimensional regions. In addition, the depth map generating unit 140 replaces the cost function held in the cost function holding unit 150 with the calculated cost function. Specifically, in the case where the calculated cost function is smaller than the smallest value of the cost function, the depth map generating unit 140 determines that the additional depth value is the depth value of a corresponding one of the two-dimensional regions, and holds the calculated cost function instead of the smallest value of the cost function held in the cost function holding unit 150.

In the case where the cost function held in the cost function holding unit 150 is more appropriate than the calculated cost function, the depth map generating unit 140 determines that the depth value corresponding to the cost function held in the cost function holding unit 150 is the depth value of a region corresponding to the depth value itself. Here, the cost functions are not replaced.

Hence, in the case where the additional depth value is set, the depth map generating unit 140 may calculate only the cost function corresponding to the additional depth value, and compare the calculated cost function with the held cost function. This feature contributes to reducing an increase in calculation cost. Furthermore, the cost function holding unit 150 may hold, among calculated cost functions, only the cost function whose depth value is the most appropriate. This feature contributes to effective use of memory resources.

Exemplified next is an operation of the three-dimensional image capturing apparatus 100 according to the embodiment of the present invention.

FIG. 12 depicts a flowchart which shows an exemplary operation of the three-dimensional image capturing apparatus 100 according to the embodiment of the present invention. It is noted that FIG. 12 shows an operation for generating the depth map based on the DFD.

First, the object designating unit 110 designates an object (S110). For example, the object designating unit 110 causes the display unit 170 to superimpose a GUI, for designating an object as shown in FIG. 6A, on an input image obtained by the capturing unit 130 and to display the input image, so that the object designating unit 110 receives a user instruction to designate an object. Then, based on the received instruction, the object designating unit 110 designates the object.

Then, the capturing unit 130 obtains the input image in capturing (S120). Here, the capturing unit 130 obtains two input images; namely, the farthest-end image and the nearest-end image.

Then, the resolution setting unit 120 sets depth values so that, in a direction parallel to a depth direction of the input images, depth resolution near the object designated by the object designating unit 110 is higher (S130). The process is specifically shown in FIG. 13.

FIG. 13 depicts a flowchart which exemplifies setting of the depth resolution according to the embodiment of the present invention.

First, the resolution setting unit 120 (or a control unit for controlling the entire three-dimensional image capturing apparatus 100) controls a lens to focus the object designated by the object designating unit 110 (S131).

Then, the resolution setting unit 120 obtains the distance to the object based on the lens information (S132), and converts the obtained distance into a depth value. Here, the lens information indicates, for example, a focal length (1 cm to ∞ (infinity)) obtained when the designated object is focused. Hence, the resolution setting unit 120 can obtain a depth position of the object designated by the object designating unit 110.

Then, based on the obtained depth position, the resolution setting unit 120 determines depth resolution (S133). In other words, the resolution setting unit 120 sets depth values each representing a different depth position, so that depth resolution near the object is higher than depth resolution apart from the object. For example, the resolution setting unit 120 sets the depth values as initial depth values as shown in (b) in FIG. 3, by shifting at least one of the depth positions close to a depth position of the designated object. Here, the depth positions are predetermined and different from each other.

With reference to FIG. 12 again, then, the depth map generating unit 140 generates depth information (depth map) corresponding to the input images (S140). Specifically, the depth map generating unit 140 generates the depth map by determining, for each of the pixels in the input images, a depth value, from among the depth values set by the resolution setting unit 120, indicating a depth position corresponding to one of the pixels. Here, based on the DFD as described above, the depth map generating unit 140 calculates a cost function with Expressions 1 and 2, and determines for each pixel the depth value having the smallest cost function.

Next, based on the input images and the depth map, the three-dimensional image generating unit 160 generates a three-dimensional image (S150). Then, the display unit 170 displays the three-dimensional image generated by the three-dimensional image generating unit 160 (S160).

Here, the stereoscopic effect adjusting unit 180 determines whether or not to have received a user instruction for adjusting a stereoscopic effect (S170). Specifically, the stereoscopic effect adjusting unit 180 causes the display unit 170 to display a stereoscopic-effect adjusting GUI, such as the stereoscopic-effect adjusting bar shown in FIGS. 7A and 7B. Then, the stereoscopic effect adjusting unit 180 determines whether or not to have received the user instruction for adjusting the stereoscopic effect via the stereoscopic-effect adjusting GUI.

In the case where the user gives an instruction to adjust the stereoscopic effect (S170: Yes), the stereoscopic effect adjusting unit 180 sets, based on the user instruction, to what level the stereoscopic effect for the object is to be enhanced or reduced (S180).

For example, when the stereoscopic effect adjusting unit 180 sets the stereoscopic effect to be enhanced, the resolution setting unit 120 sets a new depth value indicating a depth position near the object (S130). Here, there is no need to control the focus (S131) and obtain the distance to the object (S132) shown in FIG. 13. In other words, based on the depth positions of the already-obtained object, the resolution setting unit 120 may set an additional depth value near the object.

Then, the depth map generating unit 140 further calculates only the cost function corresponding to the additional depth value (S140). In other words, the cost function corresponding to the initial depth value has already been calculated, and thus does not have to be recalculated. This feature successfully curbs an increase in calculation cost.

It is noted that when the stereoscopic effect adjusting unit 180 sets the stereoscopic effect to be reduced, the resolution setting unit 120 widens the space between the depth values near the object or excludes a depth value near the object so as to update the depth values.

Then, subsequently carried out in a similar manner are: generation (S150) and display (S160) of the three-dimensional image, and determination whether or not the stereoscopic effect is to be adjusted (S170).

In the case where the user does not give an instruction not to adjust the stereoscopic effect (S170: No), the recording unit 190 records the three-dimensional image on a recording medium (S190). Here, the recording unit 190 may record the input images and the depth map.

It is noted that, in the embodiment, the three-dimensional image does not have to be generated. Instead of generating the three-dimensional image, for example, the stereoscopic effect adjusting unit 180 may generate, in Step S150, a stereoscopic-effect image showing a stereoscopic effect. The effect appears when a three-dimensional image is generated based on the input images and the depth map. Here, in Step S160, the display unit 170 displays the stereoscopic-effect image, which includes the stereoscopic effect images 221 and 222 in FIGS. 7A and 7B, showing a stereoscopic effect.

Described next is an operation carried out when another object is additionally designated, with reference to FIG. 14.

FIG. 14 depicts a flowchart which shows another exemplary operation of the three-dimensional image capturing apparatus 100 according to the embodiment of the present invention. It is noted that the flowchart in FIG. 14 is almost the same as that in FIG. 12. Thus, the differences between the flowcharts are mainly described, and the description of the same points shall be omitted.

Here, when receiving additional designation of a new object in the determination whether or not the stereoscopic effect is to be adjusted (S170), the stereoscopic effect adjusting unit 180 determines that the stereoscopic effect needs to be adjusted (S170: Yes). Here, the object designating unit 110 causes the display unit 170 to display a GUI to be used for receiving the designation of the object, and receives from the user the additional designation of the object via the GUI.

When receiving from the user the additional designation of the object (S170: Yes), the object designating unit 110 additionally designates the object instructed by the user (S175). Here, the stereoscopic effect adjusting unit 180 adjusts the stereoscopic effect of the additionally designated second object via the GUI for adjusting the stereoscopic effect (S180). In other words, the stereoscopic effect adjusting unit 180 adjusts, based on the user instruction, to what level the stereoscopic effect for the object is to be enhanced or reduced.

For example, when the stereoscopic effect adjusting unit 180 sets the stereoscopic effect to be enhanced, the resolution setting unit 120 sets a new depth value indicating a depth position near the object (S130). Here, as shown in the flowchart in FIG. 13, the resolution setting unit 120 controls the focus (S131), and obtains the distance to the newly added object (S132). Instead, the resolution setting unit 120 may also obtain the distance to the additional object by obtaining, from the depth map generated in the step S140, a depth value of the pixel position indicating the additional object.

Then, the resolution setting unit 120 newly adds a depth value, indicating the depth position near the additional object, to determine the depth resolution (S133). Then, the depth map generating unit 140 further calculates only the cost function corresponding to the additional depth value (S140). In other words, the cost function corresponding to the initial depth value has already been calculated, and thus does not have to be recalculated. This feature successfully curbs an increase in calculation cost.

FIG. 15 depicts a flowchart which shows another exemplary operation of the three-dimensional image capturing apparatus 100 according to the embodiment of the present invention. It is noted that FIG. 15 shows an operation for generating the depth map based on the DFD (focal stacking, for example). The flowchart in FIG. 15 is almost the same as that in FIG. 12. Thus, the differences between the flowcharts are mainly described, and the description of the same points shall be omitted.

The DFF requires multiple input images each of which corresponds to a different depth position. Thus, the capturing (S120) is carried out after the depth resolution setting (S130), so that, on one-on-one basis, the obtained input images correspond to multiple depth positions indicated by set multiple depth values.

It is noted that in the case where input images are previously obtained at many focal points, additional capturing does not have to be carried out. In other words, more input images than the number of the depth values may previously be obtained at focal points corresponding to the values to be obtained when the depth values are updated or another depth value is added. Thus, when the predetermined depth values are updated or when a new depth value is added, the depth values may be updated to those corresponding to the focal points of obtained input images, or the new depth value may be added.

Hence, the three-dimensional image capturing apparatus 100 according to the embodiment of the present invention sets multiple initial depth values so that the depth resolution is higher near the designated object, and generates a depth map based on the set initial depth values. Then, after having the user check the stereoscopic effect observed when the generated depth map is used, the three-dimensional image capturing apparatus 100 accepts the additional object and the setting of the stereoscopic effect adjustment.

As described above, the three-dimensional image capturing apparatus 100 according to the embodiment of the present invention includes: the capturing unit 130 which obtains an input image in capturing; the object designating unit 110 which designates an object in the input image; the resolution setting unit 120 which sets depth values each representing a different depth position, so that depth resolution is high near the designated object; and the depth map generating unit 140 which generates a depth map that corresponds to the input image, by determining, for each of regions in the input image, a depth value indicating a depth position corresponding to one of the regions, the determined depth value being included in the set depth values.

This configuration enhances the depth resolution near the designated object, which contributes to having more candidates for the depth values representing depth positions near the object. Consequently, the three-dimensional image capturing apparatus 100 can ease a cardboard effect of the designated object, and improve the three-dimensional appearance of the object. Here, the three-dimensional image capturing apparatus 100 simply enhances the depth resolution near the object greater than resolution of other regions, which, for example, eliminates the need for increasing the total number of the candidates of the depth values. Consequently, this feature contributes to curbing an increase in calculation cost.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

In the example shown in FIG. 5, the resolution setting unit 120 sets the new depth value near the second object; instead, the resolution setting unit 120 may update the initial depth values to enhance the depth resolution near the second object. Specifically, the resolution setting unit 120 may update the initial depth values by shifting at least one of the initial depth values, indicated by the initial depth values, closer to a depth value near the second object additionally designated by the object designating unit 110.

This feature allows the object designating unit 110 to additionally designate the second object when the user checks the three-dimensional appearance of the first object set first and then desires to increase the three-dimensional appearance of another object. Consequently, the three-dimensional appearance of the second object, as well as that of the first object, is successfully improved. Here, the resolution setting unit 120 simply moves the predetermined depth position and eliminates the need for increasing the number of the depth values, which contributes to curbing an increase in calculation cost.

Moreover, in the examples in FIGS. 6A and 6B, the display unit 170 shows the stereoscopic effect images 201 and 211 having a shading pattern. Instead of the stereoscopic effect images 201 and 211, the display unit 170 may display a three-dimensional image generated by the three-dimensional image generating unit 160 as a stereoscopic effect image. This feature allows the user to directly watch the three-dimensional image generated out of an input image to check the stereoscopic effect. Consequently, the user can adjust the stereoscopic effect more appropriately.

In other words, since the display unit 170 displays the three-dimensional image, the user can directly check the stereoscopic effect. Since the user can easily adjust the stereoscopic effect, the expressed stereoscopic effect is his or her desired one. Consequently, the feature makes it possible to curb an increase in calculation cost caused by expressing a three-dimensional appearance which the user does not desire.

Furthermore, the example in FIG. 13 shows how to obtain a depth position of the object from the lens information; instead, a PSF may be used to calculate cost functions for the predetermined depth values to obtain depth values of the object. Here, approximate positions are acceptable for the depth values of the object. Thus, the cost functions may be calculated for fewer depth values than those actually to be determined. In other words, the depth values of the object may be set by generating a simpler depth map (the processing corresponding to S140 in FIG. 12). This feature successfully curbs an increase in calculation cost.

In addition, when multiple objects are designated first, designation of an object may be canceled instead of adding an object (S175). Here, the depth position near the excluded object may be either added or brought close to a designated object.

Each of the processing units included in the three-dimensional image capturing apparatus according to the embodiment is typically implemented in a form of an LSI; that is, an integrated circuit (IC). The processing units may be made as separate individual chips, or as a single chip to include a part or all thereof. For example an integrated circuit according to the embodiment includes the object designating unit 110, the resolution setting unit 120, and the depth map generating unit 140.

Here, the integrated circuit is referred as LSI, but there are instances where, due to a difference in the degree of integration, the integrated circuit may be referred as IC, System-LSI, super LSI, and ultra LSI.

Furthermore, the means for circuit integration is not limited to the LSI, and implementation in the form of a dedicated circuit or a general-purpose processor is also available. In addition, it is also acceptable to use a field programmable gate array (FPGA) that is programmable after the LSI has been manufactured, and a reconfigurable processor in which connections and settings of circuit cells within the LSI are reconfigurable.

Furthermore, if an integrated circuit technology that replaces the LSI appears thorough the progress in the semiconductor technology or an other derived technology, that technology can naturally be used to carry out integration of the constituent elements. Biotechnology can be applied to the integrated circuit technology.

Moreover, part or all of the functions of the three-dimensional image capturing apparatus according to the embodiment of the present invention may be implemented by a processor, such as a central processing unit (CPU) executing a program.

In addition, the present invention may be the program and a recording medium on which the program is recorded. As a matter of course, the program may be distributed via a transmission medium, such as the Internet.

Furthermore, all the above numbers are exemplary ones to specifically describe the present invention. Thus, the present invention shall not be limited to those exemplary numbers. Moreover, relations of connections between constitutional elements are exemplary ones to specifically describe the present invention. Hence, the relations of connections to implement the functions of the present invention shall not be limited to those described above.

In addition, the embodiment is implemented in a form of hardware and/or software. The implementation in a form of hardware is also viable in a form of software, and vice versa.

Furthermore, the constitutional elements of the three-dimensional image capturing apparatus according to the embodiment of the present invention are exemplary ones to specifically describe the present invention. Thus, the three-dimensional image capturing apparatus of the present invention does not necessarily have to include all of the above constitutional elements. In other words, the three-dimensional image capturing apparatus of the present invention may include as few constitutional elements as possible to achieve the effects of the present invention.

For example, FIG. 16 depicts an exemplary block diagram showing a structure of a three-dimensional image capturing apparatus 300 according to a modification in the embodiment of the present invention. As shown in FIG. 16, the three-dimensional image capturing apparatus 300 according to a modification in the embodiment of the present invention includes the object designating unit 110, the resolution setting unit 120, the capturing unit 130, and the depth map generating unit 140. It is noted that each processing unit carries out the same processing as its equivalent found in FIG. 2 and having the same numerical reference. Thus, the details thereof shall be omitted.

Hence, a three-dimensional image capturing apparatus of the present invention successfully curbs an increase in calculation cost and increases a stereoscopic effect.

Similarly, a three-dimensional image capturing method for the three-dimensional image capturing apparatus is an exemplary one to specifically describe the present invention. Thus, the three-dimensional image capturing method for the three-dimensional image capturing apparatus does not necessarily have to include all of the steps. In other words, the three-dimensional image capturing method of the present invention may include as few steps as possible to achieve the effects of the present invention. Furthermore, the sequence of the steps to be executed is an exemplary one to specifically describe the present invention. Thus, another sequence may be employed. Moreover, part of the steps may be simultaneously (in parallel) executed with the other steps.

### INDUSTRIAL APPLICABILITY

The present invention is effective in curbing an increase in calculation cost, reducing a cardboard effect, and improving a three-dimensional appearance. The present invention is applicable to a digital camera, for example.

### REFERENCE SIGNS LIST

100 and 300 Three-dimensional image capturing apparatus
110 Object designating unit
120 Resolution setting unit
130 Capturing unit
140 Depth map generating unit
150 Cost function holding unit
160 Three-dimensional image generating unit
170 Display unit
180 Stereoscopic effect adjusting unit
190 Recording unit
200 and 210 Histogram
201, 211, 221, and 222 Stereoscopic effect image

1. A three-dimensional image capturing apparatus which generates depth information to be used for generating a three-dimensional image from an input image, the three-dimensional image capturing apparatus comprising:
a capturing unit configured to obtain the input image in capturing;
a designating unit configured to designate a first object in the input image obtained by the capturing unit;
a resolution setting unit configured to set depth values, each of which represents a different depth position, as initial depth values so that, in a direction parallel to a depth direction of the input image, depth resolution near the first object is higher than depth resolution positioned apart from the first object, the first object being designated by the designating unit; and
a depth information generating unit configured to generate the depth information corresponding to the input image by determining, for each of two-dimensional regions in the input image, a depth value, from among the depth values set by the resolution setting unit, indicating a depth position corresponding to one of the regions.

2. The three-dimensional image capturing apparatus according to claim 1,
wherein the resolution setting unit is configured to set the initial depth values by shifting at least one of the depth positions close to a depth position of the first object designated by the designating unit.

3. The three-dimensional image capturing apparatus according to claim 1,
wherein the resolution setting unit is further configured to set, as an additional depth value, a new depth value which indicates a depth position that is near the first object and different from the depth positions each indicated in a corresponding one of the initial depth values, and
the depth information generating unit is configured to determine, for each of the two-dimensional regions in the input image, a depth value from among the initial depth values and the additional depth value.

4. The three-dimensional image capturing apparatus according to claim 3, further comprising:
a display unit configured to display a stereoscopic effect image showing a stereoscopic effect to be observed when the three-dimensional image is generated based on the input image and the depth information; and
a stereoscopic effect adjusting unit configured to adjust a level of the stereoscopic effect based on an instruction from a user,
wherein, in the case where the stereoscopic effect adjusting unit sets the stereoscopic effect to be enhanced, the resolution setting unit is configured to set the additional depth value.

5. The three-dimensional image capturing apparatus according to claim 4, further comprising
a three-dimensional image generating unit configured to generate the three-dimensional image from the input image, based on the input image and the depth information,
wherein the display unit is configured to display the three-dimensional image as the stereoscopic effect image.

6. The three-dimensional image capturing apparatus according to claim 1,
wherein the designating unit is further configured to additionally designate a second object which is different from the first object and included in the input image obtained by the capturing unit,
the resolution setting unit is further configured to set, as an additional depth value, a new depth value which indicates a depth position that is near the second object and different from the depth positions each indicated in a corresponding one of the initial depth values, and
the depth information generating unit is configured to determine, for each of the two-dimensional regions in the input image, a depth value from among the initial depth values and the additional depth value.

7. The three-dimensional image capturing apparatus according to claim 1,
wherein the designating unit is further configured to additionally designate a second object which is different from the first object and included in the input image obtained by the capturing unit, and
the resolution setting unit is configured to update the initial depth values by shifting at least one of the depth positions close to a depth position of the second object additionally designated by the designating unit, each of the depth positions being indicated in a corresponding one of the initial depth values.

8. The three-dimensional image capturing apparatus according to claim 1,
wherein, for each of the two-dimensional regions in the input image, the depth information generating unit is configured to:
(a) calculate a cost function which corresponds to one of the depth values set by the resolution setting unit, and indicates appropriateness of the corresponding depth value; and
(b) determine, as a depth value for a corresponding one of the two-dimensional regions, a depth value corresponding to a cost function whose corresponding depth value is most appropriate.

9. The three-dimensional image capturing apparatus according to claim 8, further comprising a cost function holding unit configured to hold the cost function calculated by the depth information generating unit.

10. The three-dimensional image capturing apparatus according to claim 9,
wherein, for each of the two-dimensional regions in the input image, the cost function holding unit is configured to hold the cost function, calculated by the depth information generating unit, in association with one of the depth values.

11. The three-dimensional image capturing apparatus according to claim 10,
wherein the resolution setting unit is further configured to set, as an additional depth value, a new depth value which indicates a depth position that is near the first object and different from the depth positions each indicated in a corresponding one of the initial depth values, and
for each of the two-dimensional regions in the input image, the depth information generating unit is further configured to:
(a) calculate a cost function which corresponds to the additional depth value; and
(b) store the calculated cost function in the cost function holding unit in association with the additional depth value.

12. The three-dimensional image capturing apparatus according to claim 9,
wherein, for each of the two-dimensional regions in the input image, the cost function holding unit is configured to hold only the cost function, whose corresponding depth value is most appropriate, in association with the most appropriate corresponding depth value.

13. The three-dimensional image capturing apparatus according to claim 12,
wherein the resolution setting unit is further configured to set, as an additional depth value, a new depth value which indicates a depth position that is near the first object and different from the depth positions each indicated in a corresponding one of the initial depth values, and
for each of the two-dimensional regions in the input image, the depth information generating unit is further configured to:
(a) calculate a cost function which corresponds to the additional depth value;
(b) compare the calculated cost function with the cost function held in the cost function holding unit; and
(c) (i) in the case where the calculated cost function is more appropriate than the cost function held in the cost function holding unit, determine that the additional depth value is a depth value for a corresponding one of the two-dimensional regions, and replace the cost function held in the cost function holding unit with the calculated function and (ii) in the case where the cost function held in the cost function holding unit is more appropriate than the calculated cost function, determine that a depth value included in the set depth values and corresponding to the cost function held in the cost function holding unit is a depth value for a corresponding one of the two-dimensional regions.

14. The three-dimensional image capturing apparatus according to claim 1, further comprising
a display unit configured to display the input image so that the first object designated by the designating unit is enhanced.

15. A three-dimensional image capturing method for generating depth information to be used for generating a three-dimensional image from an input image, the three-dimensional image capturing method comprising:
obtaining the input image in capturing;
designating an object in the input image obtained in the obtaining;
setting depth values, each of which represents a different depth position, as initial depth values so that, in a direction parallel to a depth direction of the input image, depth resolution near the object is higher than depth resolution positioned apart from the object, the object being designated in the designating; and
generating the depth information corresponding to the input image by determining, for each of two-dimensional regions in the input image, a depth value, from among the depth values set in the setting, indicating a depth position corresponding to one of the regions.

16. A non-transitory computer readable recording medium which records a program that causes a computer to execute the three-dimensional image capturing method according to claim 15.

17. An integrated circuit which generates depth information to be used for generating a three-dimensional image from an input image, the integrated circuit comprising:
a designating unit configured to designate an object in the input image;
a resolution setting unit configured to set depth values, each of which represents a different depth position, as initial depth values so that, in a direction parallel to a depth direction of the input image, depth resolution near an object is higher than depth resolution positioned apart from the object, the object being designated by the designating unit; and
a depth information generating unit configured to generate the depth information corresponding to the input image by determining, for each of two-dimensional regions in the input image, a depth value, from among the depth values set by the resolution setting unit, indicating a depth position corresponding to one of the regions.
